(19) United States
(12) Patent Application Publication
(10) Pub. No.: US 2010/0161958 A1
(43) Pub. Date: Jun. 24, 2010

(54) Device for Realizing Security Function in Mac of Portable Internet System and Authentication Method Using the Device

(76) Inventors: Seok-Heon Cho, Iksan-city (KR); Tae-Yong Lee, Changwon-city (KR); Jae-Sun Cha, Daejeon-city (KR); Chul-Sik Yoon, Daejeon-city (KR)

Correspondence Address: Docket Clerk, PO Box Drawer 800889, Dallas, TX, 75380, US

(21) Appl. No.: 11/922,900

(22) PCT Filed: Oct. 27, 2005
(86) PCT No.: PCT/KR2005/003595

§ 371 Date: Dec. 21, 2007

(30) Foreign Application Priority Data
Jun. 22, 2005 (KR) 10-2005-0054052

(51) Int. Cl. H04L 9/32; H04L 29/06; H04L 9/14

(52) U.S. Cl. 713/151; 713/170; 380/44; 380/270

(57) ABSTRACT

The present invention relates to a device for performing a security function in a medium access control (MAC) layer in a wireless portable Internet system and an authentication method thereof. In the wireless portable Internet system including a physical layer and the MAC layer, a security sublayer (i.e., the device for performing the security function in the MAC layer) is provided on an MAC common part sublayer. The security sublayer includes a privacy key management (PKM) control management module, a traffic data encryption/authentication module, a control message processing module, a message authentication module, a Rivest Shamir Adleman (RSA)-based authentication module, an authentication control/security association (SA) control module, and an extensible authentication protocol (EAP) encapsulation/decapsulation module.

### BACKGROUND OF THE INVENTION

(a) Field of the Invention

The present invention relates to a protocol configuration of a mobile communication system. More particularly, the present invention relates to a device for realizing a security function in a medium access control (MAC) layer of a wireless portable Internet system, and an authentication method using the device.

(b) Description of the Related Art

In a wireless communication system, wireless portable Internet is a next-generation communication system that supports mobility in addition to local area data communication such as a conventional wireless local access network (LAN) that uses a fixed access point. Various standards for the wireless portable Internet have been proposed, and the international standard of the portable Internet has progressed by focusing on the IEEE 802.16e. The above-described IEEE 802.16 supports the metropolitan area network (MAN) representing an information communication network covering the LAN and the wide area network (WAN).

To securely provide various traffic data services in a wireless portable Internet system, it is required to perform security functions including authentication and authorization functions. In addition, the above functions are required to guarantee network stability and stability of the wireless portable Internet service. Recently, a privacy key management version 2 (PKMv2) which is a security key management protocol has been proposed to provide higher security. The PKMv2 performs equipment authentication of a subscriber station or a base station, or user authentication by using a Rivest Shamir Adleman (RSA)-based authentication method or an extensible authentication protocol (EAP)-based authentication method. The subscriber station and the base station share an authorization key through the above RSA and EAP authentication methods.

The authentication functions are defined in a security sublayer of a hierarchical structure of the wireless portable Internet system. In general, the hierarchical structure of a wireless metropolitan area networks (WMANs)-based wireless portable Internet system includes a physical layer and a medium access control (MAC) layer. The wireless communication functions are performed in the physical layer, and functions for controlling the wireless communication are performed in the MAC layer. In further detail, the MAC layer includes the security sublayer, a MAC common part sublayer (hereinafter, referred to as “CPS”), and a service specific convergence sublayer (hereinafter, referred to as “CS”).

The security sublayer has been conventionally defined in the MAC CS which is a higher layer of the MAC CPS in addition to the MAC CPS. However, the security sublayer should be defined only in the MAC CPS since a traffic data encryption/decryption function, a message authentication function, a privacy key management (PKM) control function, an RSA-based authentication function, and an EAP-based authentication function are performed in the security sublayer, and the above functions are similar to functions supported in the MAC CPS.

In addition, modules for generating and processing PKM-related messages are provided in the security sublayer, and in addition to the existing modules, it is required to additionally provide a module for encrypting and decrypting the traffic data, a message authentication module, and a PKM control management module.

While it is also required to provide additional modules in order to support the RSA-based authentication method and the EAP-based authentication method in the PKMv2, the modules have not been defined in the conventional security sublayer.

As described, in the MAC layer of the conventional wireless portable Internet system, the security sublayer has not been positioned at an appropriate area, and modules for performing functions supported by the security sublayer have not been clearly defined. In addition, there is a problem in that the authentication function is not efficiently supported since modules for supporting the RSA-based or EAP-based authentication method have not been provided.

Further, there is another problem in that modules for performing a predetermined communication function between respective layers in an authentication process are not appropriately arranged.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to clearly define a configuration of a security sublayer for performing a security function in a medium access control (MAC) layer in a wireless portable Internet system.

In addition, the present invention has been made in an effort to provide a device for efficiently performing the security function in the MAC layer of the wireless portable Internet system.

An exemplary security device according to an embodiment of the present invention performs the security function in the MAC layer in the wireless portable Internet system. The exemplary security device includes a message authentication module, a Rivest Shamir Adleman (RSA)-based authentication module, an extensible authentication protocol (EAP) encapsulation/decapsulation module, a control message processing module, and a privacy key management (PKM) control management module. The message authentication module performs authentication of a message transmitted/received between a subscriber station and a base station through a physical layer. The RSA-based authentication module performs equipment authentication of the subscriber station or the base station based on the message transmitted/received between the subscriber station and the base station when the message is a message related to RSA-based authentication. The EAP encapsulation/decapsulation module performs an interface with a higher layer of the MAC layer to perform the equipment authentication or user authentication based on the message transmitted/received between the subscriber station and the base station when the message is related to EAP-based authentication. The control message processing module generates a result message based on a result of the authentication performed by the RSA-based authentication module and/or the EAP encapsulation/decapsulation module to transmit the result message through the physical layer, and analyzes the result message received from a peer node through the physical layer. The PKM control management module generates a plurality of keys related to the authentication, and controls and manages the respective modules to perform the authentication by the modules.

An exemplary authentication method according to an embodiment of the present invention performs equipment authentication of a subscriber station or a base station based on a security device in a medium access control (MAC) layer of a wireless portable Internet system. In the exemplary authentication method, authentication of a message transmitted/received between the subscriber station and the base station is performed in a message authentication module of the security device; the transmitted/received message is determined and analyzed in a control message processing module of the security device; Rivest Shamir Adleman (RSA)-based equipment authentication is performed based on the message transmitted/received between the subscriber station and the base station by using the message authentication module, the control message processing module, a privacy key management (PKM) control management module, and an RSA-based authentication module of the security device when the message is a message related to the RSA-based authentication; and a message including a result of the equipment authentication is generated and transmitted by using the message authentication module and the control message processing module in the PKM control management module of the security device.

In addition, an exemplary authentication method according to another embodiment of the present invention performs equipment authentication of a subscriber station or a base station, or user authentication based on a security device in a medium access control (MAC) layer of a wireless portable Internet system. In the exemplary authentication method, authentication of a message transmitted/received between the subscriber station and the base station is performed in a message authentication module of the security device; the transmitted/received message is determined and analyzed in a control message processing module of the security device; extensible authentication protocol (EAP)-based equipment authentication or user authentication is performed based on the message transmitted/received between the subscriber station and the base station by using the message authentication module, the control message processing module, a privacy key management (PKM) control management module, and an EAP encapsulation/decapsulation module of the security device when the message is related to the EAP-based authentication; and a message including a result of the equipment authentication or the user authentication is generated and transmitted in the PKM control management module of the security device by using the message authentication module and the control message processing module.

### BRIEF DESCRIPTION OF THE DRAWINGS

FIG. 1 shows a diagram of a configuration of a wireless portable Internet system according to an exemplary embodiment of the present invention.

FIG. 2 shows a diagram of a configuration of a security sublayer defined in the wireless portable Internet system.

FIG. 3 shows a diagram of a configuration of a security device for performing a security function in a medium access control (MAC) layer according to the exemplary embodiment of the present invention.

FIG. 4 shows a flowchart representing an authentication process in a first authentication method according to the exemplary embodiment of the present invention.

FIG. 5 shows a flowchart representing an authentication process in a second authentication method according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive.

Throughout this specification and the claims that follow, unless explicitly described to the contrary, the word “comprise” or variations such as “comprises” or “comprising” will be understood to imply the inclusion of stated elements but not the exclusion of any other elements.

In addition, the word “module” will be understood to indicate a unit for processing a predetermined function or operation, which may be realized by hardware, software, or a combination thereof.

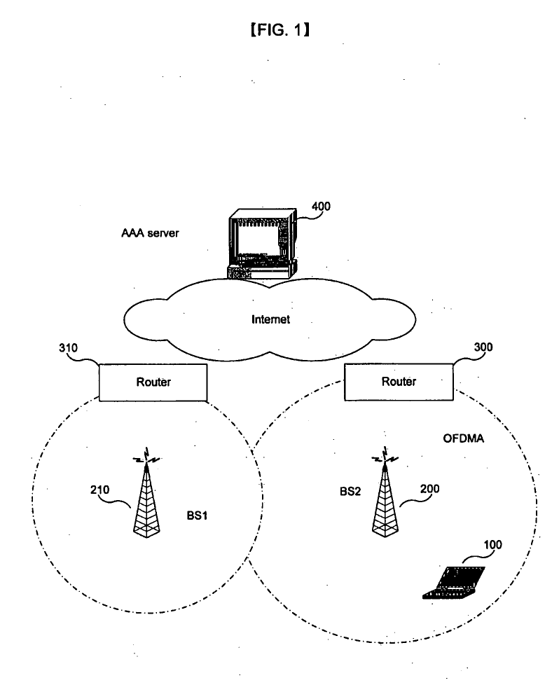

FIG. 1 shows a diagram of a configuration of a wireless portable Internet system according to an exemplary embodiment of the present invention.

The wireless portable Internet system includes a subscriber station 100, base stations 200 and 210 (hereinafter, denoted by 200 for convenience of description), routers 300 and 310 accessed to the base station through a gateway, and an authentication, authorization, and accounting (AAA) server 400 accessed to the routers 300 and 310 to authenticate the subscriber station 100.

When the subscriber station 100 and the base stations 200 and 210 communicate with each other, they negotiate an authentication mode for authenticating the subscriber station 100, and perform an authentication process according to the negotiated authentication mode. When a Rivest Shamir Adleman (RSA)-based authentication method is selected, an RSA-based authentication operation is performed in a medium access control (MAC) layer of the subscriber station and the base station, and when an extensible authentication protocol (EAP)-based authentication method is selected, an EAP-based authentication operation is performed between the subscriber station and an EAP layer of the AAA server.

In general, a hierarchical structure of the wireless portable Internet system includes a physical layer for performing wireless communication functions including modulation/demodulation and encoding functions, and the MAC layer for performing various functions.

The MAC layer for performing a control operation that enables the wireless communication includes an MAC common part sublayer (hereinafter, referred to as “MAC CPS”) for performing system access, bandwidth allocation, traffic connection establishment and maintenance, and quality of service (QoS) management functions, and a service specific convergence sublayer (hereinafter, referred to as “MAC CS”) for performing payload header suppression and QoS mapping functions.

In an IEEE 802.16 metropolitan area network (MAN)-based wireless portable Internet system, a security sublayer is defined in the MAC CS which is a higher layer of the MAC CPS, and the security sublayer performs security functions including equipment authentication and security key exchange functions for the subscriber station and the base station, and an encoding function. A configuration of the security sublayer will now be described.

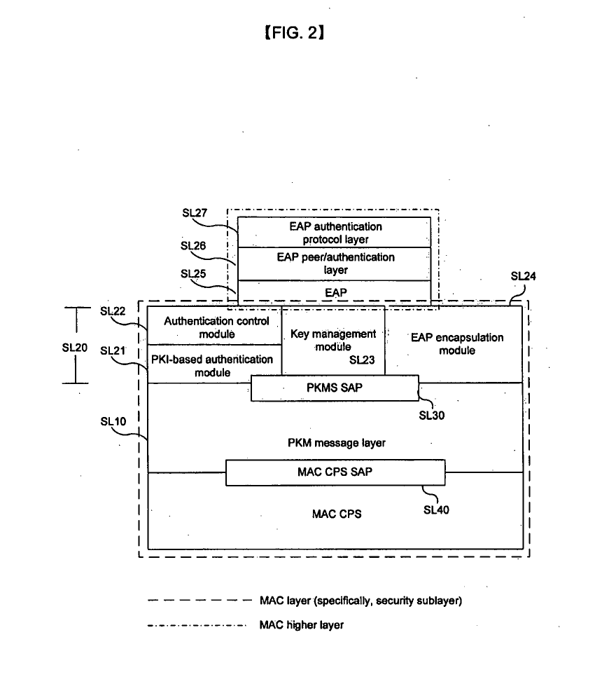

FIG. 2 shows a diagram of the configuration of the security sublayer defined in the wireless portable Internet system.

The conventional security sublayer uses an MAC CPS service access point (hereinafter, referred to as “SAP”) to communicate with the MAC CPS, and therefore the security sublayer is provided in the MAC CS.

The conventional security sublayer includes a privacy key management (PKM) message layer SL10 and an authentication process layer SL20, and the PKM message layer SL10 and the authentication layer SL20 are separated by a privacy key management sublayer (PKMS) SAP SL30.

PKM-related MAC messages are generated and processed in the PKM message layer SL10.

The authentication process layer SL20 includes a public key infrastructure (PKI)-based authentication module SL21, an authentication control module SL22, a key management module SL23, and an EAP encapsulation module SL24. In addition, the security sublayer includes an EAP layer SL25 for transmitting a higher EAP authentication protocol, an EAP peer/authentication layer SL26, and an EAP authentication protocol layer SL27 which are higher layers of the MAC layer. However, since the EAP peer/authentication layer SL26 is used for the AAA server 400 and not for the subscriber station, it may not be defined in the structure of the security sublayer.

The PKI-based authentication module SL21 verifies a certificate of a subscriber station or a base station (e.g., X.509 certificate) to authenticate a peer node, and the authentication control module SL22 authenticates the peer node to control processes for generating an authorization key. The key management module SL23 manages keys (e.g., a traffic encryption key) generated by the authorization key, and the EAP encapsulation module SL24 encapsulates higher EAP authentication protocol messages to transmit the encapsulated higher EAP authentication protocol messages to the peer node. The higher EAP authentication protocol is transmitted in the EAP layer SL25 and the EAP peer/authentication layer SL26, and an actual authentication is performed in the EAP authentication protocol layer SL27.

The security sublayer consisting of these structures should be provided in the MAC CPS since it performs the same function as the MAC CPS, but the conventional security sublayer is problematically provided in the MAC CS.

In addition, primitives for the PKMS SAP SL30 should be defined to guarantee the compatibility between the PKM message layer SL10 and the authentication layer SL20, but they are not defined in the PKMS SAP SL30 of the conventional security sublayer.

In addition to the above modules, the additional modules for performing various detailed functions of the security sublayer are required to be defined to efficiently operate the security sublayer, but they are not defined. For example, it is required to provide a module for encrypting and decrypting traffic data, a module for authenticating the PKM-related message, and a module for controlling and managing the PKM.

In the wireless portable Internet system, a PKMv1 (PKM version 1) and the PKMv2 (PKM version 2) are defined. The PKMv2 includes various detailed functions suggested to solve the problem of low stability of the PKMv1.

In the PKMv1 and PKMv2, various authorization policies are defined. The PKMv1 supports the RSA-based authentication method for authorizing the equipment of the subscriber station 100.

However, in the PKMv2, there is a case that supports the RSA-based authentication method for mutually authorizing the equipment of the subscriber station and the base station, a case that supports the EAP-based authorization method using the higher EAP authentication protocol to perform the equipment authentication of the subscriber station or the base station, or the user authentication, a case that supports the RSA-based authentication method for performing the equipment authentication of the subscriber station or the base station and the EAP-based authentication method for performing the user authentication, and a case that supports the RSA-based authentication method for performing the equipment authentication of the subscriber station or the base station and an authenticated EAP-based authorization method using keys obtained from the RSA based authorization method to perform the user authentication.

The PKM message layer SL10, the PKI-based authentication module SL21, the authentication control module SL22, and the key management module SL23 are used when the authentication based on the PKMv1 is performed in the security sublayer. In addition, when the authentication is performed based on the PKMv2, the EAP encapsulation module SL24 is also used in addition to the PKM message layer SL10, the PKI-based authentication module SL21, the authentication control module SL22, and the key management module SL23. While it has been described that the EAP layer SL25 is compatible with the authentication control module SL22, the key management module SL23, and the EAP encapsulation module SL24 in the PKMv2, the EAP layer SL25 is required to be defined as actually being compatible only with the EAP encapsulation module SL24.

Accordingly, in addition to the modules defined in the conventional security sublayer, it is required to provide additional modules for performing the authentication in the above manner.

In further detail, it is required to provide an RSA-based authentication module for performing the RSA-based authentication method. In addition, since the equipment authentication or the user authentication is performed in a higher authentication protocol rather than being performed in the MAC layer, the security sublayer in the MAC is required to include an EAP encapsulation/decapsulation module so as to be compatible with the higher EAP authentication protocol. Further, it is required to provide an authentication/security association (SA) control module for the subscriber station authenticated by the RSA-based authentication module and the module for performing an EAP compatibility process.

It is also required to provide the EAP authentication protocol layer and the EAP layer for performing the EAP-based authentication method. Since the EAP authentication protocol layer and the EAP layer are higher layers than the MAC layer in the wireless portable Internet, and the two layers are provided in the subscriber station and the AAA server, they are deviated from a range of the security sublayer. The EAP layer transmits the EAP authentication protocol to the subscriber station and the AAA server, and the EAP authentication protocol layer actually performs the equipment authentication or the user authentication based on the EAP.

In addition, while the EAP layer communicates with the EAP encapsulation module, the authentication control module, and the key control module in the conventional security sublayer, data of the EAP layer should be transmitted to the EAP layer of the peer node only through the EAP encapsulation/decapsulation module.

While focusing on the problems of the conventional security sublayer, the security sublayer according to an exemplary embodiment of the preset invention will now be described.

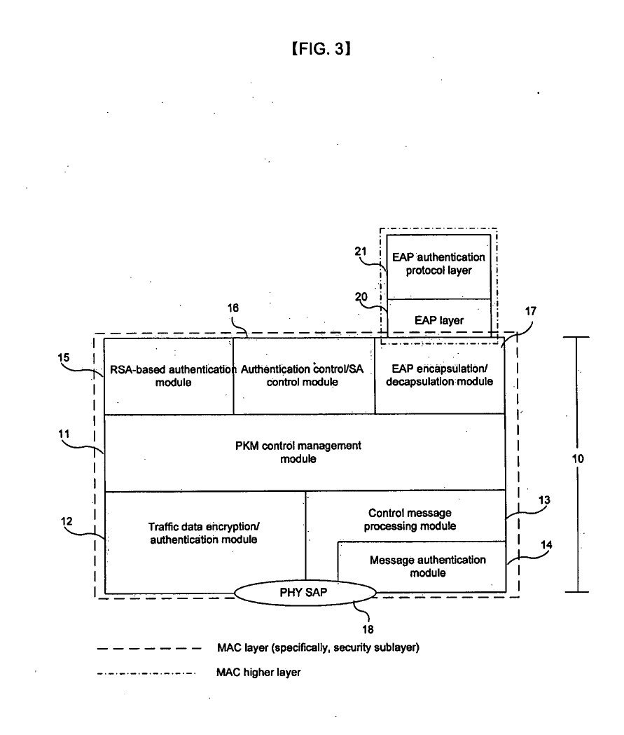

FIG. 3 shows a diagram of a configuration of the security sublayer defined in the wireless portable Internet system according to the exemplary embodiment of the present invention (i.e., the configuration of a device for realizing respective functions of the security sublayer in the MAC layer).

The various MAC messages for performing the access control are generated and processed in the MAC CPS, and various functions are controlled and performed according to the MAC messages. Since various PKM-related MAC messages for performing the authentication are generated and processed in the security sublayer in a like manner of the MAC CPS, and various authentication functions are controlled and performed according to the PKM-related MAC messages, the device for performing security functions of the MAC layer according to the exemplary embodiment of the present invention (i.e., the security layer 10) is provided in the MAC CPS as shown in FIG. 3. Therefore, the security sublayer 10 according to the exemplary embodiment of the present invention is provided in the MAC CPS so as to communicate with the physical layer in a like manner of the MAC CPS, and specifically, it communicates with the physical layer through a physical (PHY) SAP 18.

As shown in FIG. 3, the security sublayer 10 according to the exemplary embodiment of the present invention includes a PKM control management module 11, a traffic data encryption/authentication module 12, a control message processing module 13, a message authentication module 14, an RSA-based authentication module 15, an authentication control/SA control module 16, and an EAP encapsulation/decapsulation module 17.

The PKM control management module 11 controls and manages modules in the security sublayer, and generates various keys for controlling and managing the modules. The authentication function in the wireless portable Internet system supports to securely transmit the traffic data and signal messages to an authenticated node. Therefore, the traffic data encryption/authentication module 12 encrypts and decrypts the traffic data or authenticates the traffic data.

The control message processing module 13 generates and analyzes the PKM-related MAC message, and the message authentication module 14 performs the authentication for the MAC messages transmitted and received through the physical layer. The message authentication module 14 uses a hashed message authentication code (HMAC) in the PKMv1, and it supports the HMAC, cipher-based message authentication code (CMAC), and various short-HMACs in the PKMv2.

The RSA-based authentication module 15 uses a certificate (e.g., X.509 certificate) to perform the RSA-based authentication. The RSA-based authentication module 15 performs the authorization of the subscriber station in the PKMv1, and performs the mutual authorization of the subscriber station and the base station in the PKMv2.

The higher EAP authentication protocol is used to perform the user authentication, as well as the equipment authentication. The EAP encapsulation/decapsulation module 17 encapsulates or decapsulates messages so as to effectively transmit the messages of the EAP authentication protocol to the peer node.

The authentication control/SA control module 16 controls an authorization key state machine related to the equipment authentication and the user authentication, and a traffic encryption key state machine related to a traffic encryption key (TEK) for encrypting the traffic data.

The EAP layer 18 for transmitting the higher EAP authentication protocol used in the PKMv2 and the EAP authentication protocol layer 19 for actually performing the equipment authentication or the user authentication are defined in a higher layer of the security sublayer 10. More specifically, according to the exemplary embodiment of the present invention, the EAP layer 18 transmits the data to the EAP layer of the peer node only through the EAP encapsulation/decapsulation module 17. In addition, the EAP layer and the EAP authentication protocol layer are higher layers than the security sublayer, and accordingly, they are not included in the security sublayer and the MAC layer.

A method for performing the authentication by the subscriber station and the base station based on the device for performing the security functions in the MAC layer (i.e., based on the security sublayer of the wireless portable Internet system) will now be described.

The subscriber station and the base station according to the exemplary embodiment of the present invention performs the authentication through the security sublayer of the above configuration, and here, the security sublayers of the subscriber station and the base station are denoted by the same element number.

Hereinafter, the description will be based on PKMv2 authorization policies. The subscriber station 100 and the base station 200 may share a primary authorization key (PAK) as a result of the RSA-based authentication, and the subscriber station 100 and the base station 200 may share a pairwise master key (PMK) as a result of the EAP-based authentication or the authenticated EAP-based authentication. In addition, the subscriber station 100 and the base station 200 use the shared PAK or PMK to respectively generate authorization keys that are equal to each other.

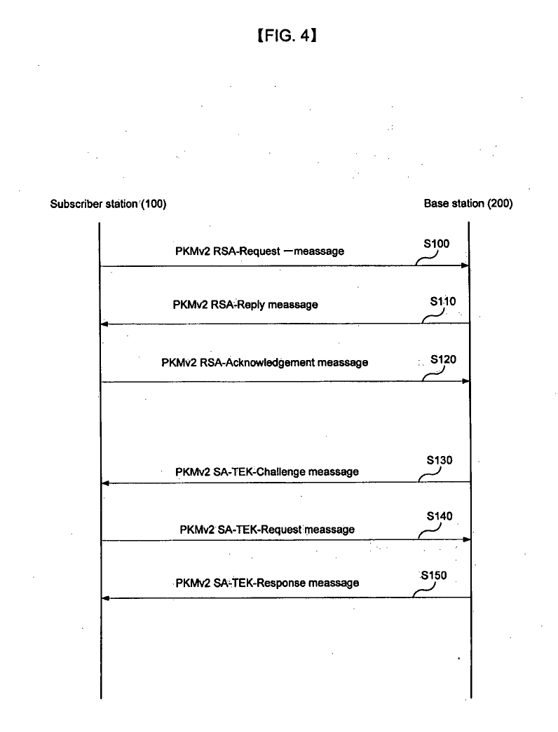

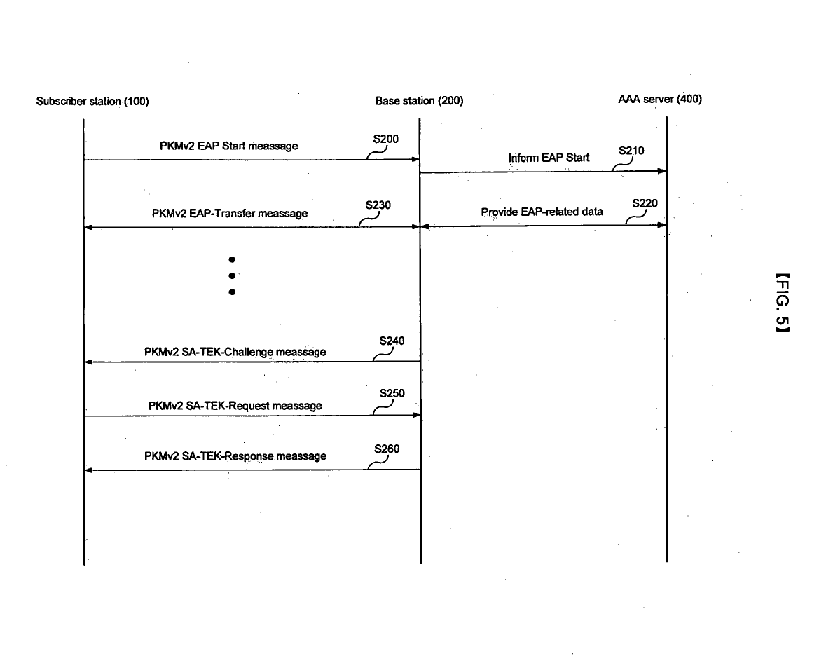

FIG. 4 and FIG. 5 show flowcharts representing authentication processes of the wireless portable Internet system according to the exemplary embodiment of the present invention. More specifically, FIG. 4 shows a flowchart representing an authentication process according to the RSA-based authentication method defined in the PKMv2, and FIG. 5 shows a flowchart representing an authentication process according to the EAP-based authentication method defined in the PKMv2.

After downlink synchronization is established between the subscriber station 100 and the base station 200, and a ranging process is performed, a negotiation on basic functions of the subscriber station is performed to establish a connection, and a predetermined authentication mode may be selected in the subscriber station basic capability negotiation process.

When the RSA-based authentication method is selected as the authentication mode, the subscriber station 100 transmits a subscriber station digital certificate to the base station through a PKM message which is an authentication message among MAC messages. In further detail, the subscriber station 100 adds a certificate of the subscriber station to a PKMv2 RSA-Request message, and transmits the message to the base station 200 in step S100. The message transmitted from the subscriber station 100 is transmitted to the MAC layer through the physical layer. Specifically, it is transmitted to the control message processing module 13 of the security sublayer 10 in the MAC CPS. When the message is required to be authenticated, the message authentication module 14 may authenticate the message.

The base station 200 receiving the PKMv2 RSA-Request message from the subscriber station 100 performs the equipment authentication of a corresponding subscriber station, and when the equipment authentication of the subscriber station is successfully completed, the base station 200 transmits a PKMv2 RSA-Reply message including a certificate of the base station 200 and a pre-PAK encrypted as a public key of the subscriber station 100 in step S110.

In more detail, in the security sublayer 10 of the base station 200, when the received PKMv2 RSA-Request message includes a field for performing a message authentication function, the message authentication module 14 authenticates the message. The control message processing module 13 analyzes the authenticated message and transmits the analyzed message to the PKM control management module 11, and the PKM control management module 11 transmits the message to the RSA-based authentication module 15 to perform the RSA-based authentication.

The PKM control management module 11 receives the authentication result of the RSA-based authentication module 15, the PKM control management module 11 controls the control message processing module 13 to generate the PKMv2 RSA-Reply message including the authentication result according to success or failure of the authentication for the subscriber station, and the subscriber station 100 receives the message including the authentication result through the physical layer.

The subscriber station 100 receiving the PKMv2 RSA-Reply message from the base station 200 verifies the certificate of the base station 200 and transmits a PKMv2 RSA-Acknowledgement message to the base station when the authentication for the base station is completed, and then the RSA-based mutual authentication is finished in step S120. That is, the authentication is performed by the respective modules based on received messages in the security sublayer 10 of the subscriber station 100 as described above. In further detail, when the received PKMv2 RSA-Reply message includes the field for performing the message authentication function, the message is authenticated by the message authentication module 14, the authenticated message is transmitted to the RSA-based authentication module 15 through the control message processing module 13 and the PKM control management module 11, and the RSA-based authentication is also performed by the subscriber station. In addition, the authentication result of the RSA-based authentication module 15 is added to the PKMv2 RSA-Acknowledgement message by the PKM control management module 11 and the control message processing module 13, and the message is transmitted to the base station 200.

In the base station 200, when the PKMv2 RSA-Acknowledgement message includes the field for performing the authentication, the message is authenticated by the message authentication module 14, and the authenticated message is transmitted to the PKM control management module 11 through the control message processing module 13. The PKM control management module 11 is notified of the success of the RSA-based authentication based on the message, and informs the authentication control/SA control module 16 of the success of the RSA-based authentication.

When the RSA-based authentication process between the subscriber station and the base station is successfully performed, the PKM control management module 11 in the security sublayer of the subscriber station and the base station uses the messages received from the peer node and events generated in the PKM control management module 11 to provide information to the authorization key state machine of the authentication control/SA control module 16.

Accordingly, the subscriber station 100 and the base station 200 may share the pre-PAK, and they may share the PAK since they respectively generate the PAK by using the pre-PAK. In addition, since the subscriber station 100 and the base station 200 generate the authorization key by using the shared PAK, they may share the same authorization key.

Since the base station 200 generates a PAK identifier (a PAK sequence number) for distinguishing the PAK and transmits the PKMv2 RSA-Reply message including the PAK identifier and a PAK lifetime in step S110, the subscriber station 100 and the base station 200 may share the PAK identifier and the PAK lifetime.

After the RSA-based authentication is performed, it is required to inform the subscriber station 100 and the base station 200 of the AK sequence number which is the identifier of the authorization key, a security association identifier (SA-ID), and algorithms used for each SA, and therefore a 3-Way SA-TEK exchange process is performed between the subscriber station 100 and the base station 200.

The base station 200, having generated the authorization key by the RSA-based authorization policy, transmits a PKMv2 SA-TEK-Challenge message including the sequence number of the authorization key to the subscriber station 100 in step S130. The sequence number of the authorization key is managed by the PKM control management module 11, and the authorization key sequence number which is included in the PKMv2 SA-TEK-Challenge message is transmitted through the control message processing module 13 and the message authentication module 14 when the message authentication function is supported.

The PKMv2 SA-TEK-Challenge message transmitted to the subscriber station 100 is transmitted to the PKM control management module 11 through the control message processing module 13 and the message authentication module 14 in the security sublayer of the subscriber station, and the PKM control management module 11 finally processes the message, and transmits a PKMv2 SA-TEK-Request message to the base station through the control message processing module 13 and the message authentication module 14 in step S140 so as to inform the base station 200 of supportable encryption algorithms in the subscriber station.

The PKMv2 SA-TEK-Request message is transmitted to the PKM control management module 11 through the control message processing module 13 and the message authentication module 14 in the security sublayer 10 of the base station 200, and is finally processed. The PKM control management module 11 informs the subscriber station 100 of the SAIDs and algorithms corresponding to a supportable primary SA and a plurality of static SAs by using a PKMv2 SA-TEK-Response message generated by the control message processing module 13 and the message authentication module 14, and thereby the 3-Way SA-TEK process is finished in step S150.

In addition, after transmitting the PKMv2 SA-TEK-Response message, the PKM control management module 11 of the security sublayer in the base station or the subscriber station informs the authentication control/SA control module 16 of the final success of the authentication process, and starts a plurality of traffic encryption key state machines.

When the 3-Way SA-TEK exchange process is performed between the subscriber station and the base station, the PKM control management module 11 in the security sublayer of the subscriber station and the base station uses the message received from the peer node and the event generated by the PKM control management module 11 to provide information to the authorization key state machine of the authentication control/SA control module 16.

In the above process, the subscriber station 100 and the base station 200 share the authorization key identifier.

When the EAP-based authentication method based on the standardized EAP authentication protocol of the higher layer is selected as an authentication mode in a subscriber station basic capability negotiation process, an authentication process is performed as shown in FIG. 5.

As shown in FIG. 5, the subscriber station 100 transmits a PKMv2 EAP-start message to the base station in step S200 so as to inform the EAP authentication protocol of a start of the EAP-based authentication process. The base station 200 receiving the PKMv2 EAP-start message selectively performs the message authentication by the message authentication module 14, and the control message processing module 13 transmits the authenticated message to the PKM control management module 11. The PKM control management module 11 informs the AAA server 400 that the EAP-based authentication process is started in step S210, based on the message.

Accordingly, the AAA server 400 provides data related to EAP authentication to the EAP authentication protocol layer 21 (which is higher than the security sublayer 10) in the AAA server 400 so as to transmit the data to the EAP layer 20 in step S220.

Subsequently, a PKMv2 EAP-Transfer message is transmitted several times between the subscriber station 100 and the base station 200 in step S230 according to the EAP authentication process, and the equipment authentication for the subscriber station or the base station, or the user authentication is performed in the EAP authentication protocol layer 21 in the subscriber station and the AAA server. The base station 200 receiving the PKMv2 EAP-Transfer message several times from the subscriber station 100 transmits EAP-related data to the AAA server 400, and the base station 200 receiving the EAP-related data several times from the AAA server 400 transmits the respective EAP-related data to the subscriber station 100 by sending the PKMv2 EAP-Transfer messages.

In further detail, the subscriber station 100 and the base station 200 transmit subscriber authentication information (i.e., transport layer security (TLS) data or tunneled transport layer security (TTLS) data which are security protocols of an application layer upon the EAP) to the peer node (the subscriber station or the base station) by sending the PKMv2 EAP-transfer message, for example, by using an EAP data payload.

The message authentication module 14 selectively authenticates the PKMv2 EAP-Transfer message, the control message processing module 13 analyzes the message to transmit it to the PKM control management module 11, and the PKM control management module 11 transmits the PKMv2 EAP-Transfer message to the EAP encapsulation/decapsulation module 17. The EAP encapsulation/decapsulation module 17 extracts the data related to the higher EAP authentication protocol (i.e., the data to be transmitted the data to the higher layer) and encapsulates the extracted data to transmit the encapsulated data to the EAP layer 20 which is a higher layer. The EAP layer 20 decapsulates the data, transmits the decapsulated data to the EAP authentication protocol layer 21, and the EAP authentication protocol layer 21 performs an actual authentication. In addition, the EAP layer 20 receiving the data related to the higher EAP authentication protocol from the EAP authentication protocol layer 21 transmits the data to the EAP encapsulation/decapsulation module 17 of the security sublayer. The EAP encapsulation/decapsulation module 17 decapsulates the data received from the EAP layer 20, and transmits the data to the PKM control management module 11. Since the EAP data are transmitted to/received from the EAP layer 20 only through the EAP encapsulation/decapsulation module 17 according to the exemplary embodiment of the present invention, the EAP data are transmitted and received more efficiently and quickly compared to the conventional art.

The control message processing module 13 and the message authentication module 14 generate the PKMv2 EAP-Transfer message for transmitting the higher EAP authentication data under a control of the PKM control management module 11, selectively add the message authentication function to the message, and transmit the message to the subscriber station 100 through the physical layer.

The step S220 for performing PKMv2 EAP-Transfer message exchange between the subscriber station 100 and the base station 200 and performing the EAP-related data exchange between the base station 200 and the AAA server 400 may be achieved several times according to the higher EAP authentication protocol characteristics, and messages and data are exchanged in the step S220 in a like manner of the above-described method.

The subscriber station 100 and the base station 200 generate and share the PMK in the above-described processes. In addition, since the subscriber station 100 and the base station 200 may generate the AK by using the shared PMK, the same AK may be shared by the subscriber station 100 and the base station.

In the security sublayer of the subscriber station 100, when the control management module 11 receives information on the success of the EAP-based authentication process from the EAP authentication protocol layer 21 through the EAP layer 20, the control management module 11 requests the control message processing module 13 to generate a PKMv2 EAP-Transfer Complete message. When selectively supporting the message authentication function to the above message, the control management module 11 requests the message authentication module 14 to add the message authentication function. In addition, the PKMv2 EAP-Transfer Complete message generated according to the requests is transmitted to the base station 200.

The base station 200 receiving the message performs the message authentication by the message authentication module 14, the control message processing module 13 analyzes the message, and the PKM control management module 11 is notified of the success of the EAP-based authentication process.

In addition, when being notified of the final success of the EAP-based authentication, the PKM control management module 11 informs the authentication control/SA control module 16 of the success of the EAP-based authentication.

After performing the EAP-based authentication, in a like manner of the RSA-based authentication, the 3-Way SA-TEK exchange for sharing the authorization key sequence number which is the identifier of the authentication, the SA-IDs, and the algorithms used for each SA by the subscriber station 100 and the base station 200 is performed in steps S240 to S260.

When the EAP-based authentication process is performed between the subscriber station and the base station, or when the 3-Way SA-TEK exchange is performed between the subscriber station and the base station, the PKM control management module 11 in the respective security sublayers 10 of the subscriber station and the base station uses the message received from the peer node and the event generated by the PKM control management module 11 to provide information to the authorization key state machine of the authentication control/SA control module 16.

When other authentication methods defined in the PKMv2 may be used in addition to the above authentication method, the methods as shown in FIG. 4 and FIG. 5 may be used.

After performing the authentication, the subscriber station 100 may transmit a PKMv2 Key-Request (which is a key request message for requesting an encryption key for traffic security) to the base station 200. In this case, in the base station 200, the message authentication module 14 of the security sublayer 10 performs the message authentication function, the control message processing module 13 analyzes the message, and the PKM control management module 11 generates the traffic encryption key according to the result of the analyzed message and transmits a PKMv2 Key-Reply which is a key response message including the traffic encryption key to the subscriber station 100.

In the subscriber station 100 receiving the key response message, the message authentication module 14 of the security sublayer 10 performs the message authentication function, the control message processing module 13 analyzes the message, and the PKM control management module 11 shares the traffic encryption key received based on the message.

In addition, in the exemplary embodiment of the present invention, other normal MAC messages except the authentication-related message are transmitted to the security sublayer 10 of the peer node through the physical layer, are authenticated by the message authentication module 14, and are analyzed by the control message processing module 13. Further, when the normal MAC messages are transmitted to the peer node, the control message processing module 13 generates a message, and the message authentication module 14 adds the message authentication function.

The traffic data are transmitted to the security sublayer 10 through the physical layer, and the traffic data encryption/authentication module 12 decrypts and authenticates the traffic data. In addition, when the traffic data are transmitted to the peer node, the traffic data encryption/authentication module 12 encrypts the traffic data to be transmitted, and adds the authentication function.

The above method may be realized as a program recorded in a computer-readable recording medium. Various kinds of recoding devices may be used for the recording medium if the recording devices are readable on a computer. For example, a CD-ROM, magnetic tape, or a floppy disk may be used for the recording medium, and the recoding medium may be realized as a carrier wave type (e.g., transmission through the Internet).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to the exemplary embodiment of the present invention, the configuration of the security sublayer for the authentication in the wireless portable Internet system is efficiently defined. Therefore, the following advantages are achieved.

Firstly, the authentication function may be appropriately performed since the security sublayer is defined to be provided in the same layer as the MAC CPS in the MAC layer.

Secondly, the security sublayer may be efficiently and systematically managed since the various detailed functions for performing the authentication are defined in the security sublayer.

1. A security device for realizing security functions in a medium access control (MAC) layer in a wireless portable Internet system, the security device comprising:
a message authentication module for authenticating a message transmitted/received between a subscriber station and a base station through a physical layer;
a Rivest Shamir Adleman (RSA)-based authentication module for performing equipment authentication of the subscriber station or the base station based on the message transmitted/received between the subscriber station and the base station when the message relates to RSA-based authentication;
an extensible authentication protocol (EAP) encapsulation/decapsulation module for performing an interface with a higher layer of the MAC layer to perform the equipment authentication or user authentication based on the message transmitted/received between the subscriber station and the base station when the message relates to EAP-based authentication;
a control message processing module for generating a result message based on a result of the authentication performed by the RSA-based authentication module and/or the EAP encapsulation/decapsulation module, transmitting the result message through the physical layer, and analyzing the result message received from a peer node through the physical layer; and
a privacy key management (PKM) control management module for generating a plurality of keys related to the authentication, and controlling and managing the respective modules to perform the authentication by the modules.

2. The security device of claim 1, further comprising a traffic encryption/traffic data authentication module accessed to the physical layer, the traffic encryption/traffic data authentication module for encrypting, decrypting, and authenticating traffic data transmitted to/received from the authenticated subscriber station.

3. The security device of claim 1, further comprising an authentication control/security association (SA) control module for controlling an authorization key state machine corresponding to the authenticated subscriber station, and a traffic encryption key state machine corresponding to a traffic encryption key used for encrypting the traffic data.

4. The security device of claim 1, wherein the message authentication module uses a hashed message authentication code (HMAC) to authenticate the message in a privacy key management version 1 (PKMv1) authentication method, and uses one among the HMAC and a cipher-based message authentication code (CMAC) to authenticate the message in a PKMv2 authentication method.

5. The security device of claim 1, wherein the RSA-based authentication module authorizes the subscriber station in the PKMv 1 authentication method, and mutually authorizes the subscriber station and the base station in the PKMv2 authentication method.

6. The security device of claim 1, wherein the MAC layer comprises a MAC common part sublayer and a service specific convergence sublayer, and the security device is provided on the MAC common part sublayer.

7. The security device of claim 1, further comprising a physical service access point for communicating with the physical layer.

8. The security device of claim 1, wherein the higher layer comprises:
an EAP layer for transmitting a higher EAP authentication protocol; and
an EAP authentication protocol layer for performing the equipment authentication or the user authentication, wherein
the EAP encapsulation/decapsulation module performs an interface with the EAP layer to transmit/receive higher EAP authentication data.

9. An authentication method for performing equipment authentication of a subscriber station or a base station based on a security device in a medium access control (MAC) layer of a wireless portable Internet system, the authentication method comprising:
authenticating a message transmitted/received between the subscriber station and the base station by using a message authentication module of the security device;
determining and analyzing the transmitted/received message by using a control message processing module of the security device;
performing Rivest Shamir Adleman (RSA)-based equipment authentication based on the message transmitted/received between the subscriber station and the base station, by using the message authentication module, the control message processing module, a privacy key management (PKM) control management module, and an RSA-based authentication module of the security device, when the message relates to the RSA-based authentication; and
generating and transmitting a message including a result of the equipment authentication, by using the message authentication module, the control message processing module, and the PKM control management module of the security device.

10. An authentication method for performing equipment authentication of a subscriber station or a base station, or user authentication based on a security device in a medium access control (MAC) layer of a wireless portable Internet system, the authentication method comprising:
authenticating a message transmitted/received between the subscriber station and the base station by a message authentication module of the security device;
determining and analyzing the transmitted/received message by a control message processing module of the security device;
performing extensible authentication protocol (EAP)-based equipment authentication or user authentication based on the message transmitted/received between the subscriber station and the base station, by using the message authentication module, the control message processing module, a privacy key management (PKM) control management module, and an EAP encapsulation/decapsulation module of the security device when the message relates to the EAP-based authentication; and
generating and transmitting a message including a result of the equipment authentication or the user authentication, by using the message authentication module, the control message processing module, and the PKM control management module of the security device.

11. The authentication method of claim 10, further comprising sharing an authorization key-related sequence number which is an identifier of an authorization key related to the authentication, a security association identifier (SA-ID), and an algorithm for each SA between the subscriber station and the base station, by using the PKM control management module, the message authentication module, and the control message processing module.

12. The authentication method of claim 10, further comprising encrypting and decrypting traffic data transmitted/received between the authenticated subscriber station and base station, and authenticating the traffic data, by using a traffic data encryption/authentication module of the security device.

13. The authentication method of claim 11, further comprising managing an authorization key state machine and a traffic encryption key state machine of an authentication control/SA control module based on a message received from a peer node and an event generated by an own node, by using the PKM control management module of the security device.

14. A method for realizing a security sublayer in a medium access control (MAC) layer of a wireless portable Internet system, the method comprising:
forming a message authentication module accessed to a physical layer, the message authentication module for authenticating a message transmitted/received between a subscriber station and a base station;
forming a control message processing module accessed to the physical layer and located at a module higher than the message authentication module, the control message processing module for processing the transmitted/received message;
forming a Rivest Shamir Adleman (RSA)-based authentication module for performing equipment authentication of the subscriber station or the base station based on the transmitted/received message when the message relates to RSA-based authentication;
forming an extensible authentication protocol (EAP) encapsulation/decapsulation module accessed to a higher layer of the MAC layer, the EAP encapsulation/decapsulation module for performing the equipment authentication or user authentication based on the transmitted/received message when the message relates to EAP-based authentication; and
forming a privacy key management (PKM) control management module located among the control message processing module, the RSA-based authentication module, and the EAP encapsulation/decapsulation module, the PKM control management module for generating a result message based on a result of the equipment authentication or the user authentication and transmitting the result message through the physical layer.

15. The authentication method of claim 9, further comprising sharing an authorization key-related sequence number which is an identifier of an authorization key related to the authentication, a security association identifier (SA-ID), and an algorithm for each SA between the subscriber station and the base station, by using the PKM control management module, the message authentication module, and the control message processing module.

16. The authentication method of claim 9, further comprising encrypting and decrypting traffic data transmitted/received between the authenticated subscriber station and the base station, and authenticating the traffic data, by using a traffic data encryption/authentication module of the security device.

17. The authentication method of claim 15, further comprising managing an authorization key state machine and a traffic encryption key state machine of an authentication control/SA control module based on a message received from a peer node and an event generated by an own node, by using the PKM control management module of the security device.
